(19) United States
(12) Patent Application Publication
(10) Pub. No.: US 2010/0081369 A1
(43) Pub. Date: Apr. 1, 2010

(54) PERSONAL VENTILATION IN AN AIRCRAFT ENVIRONMENT

(76) Inventors: David R. Space, W. Everett, WA (US); Charles A. Stout, Everett, WA (US); James A. Fullerton, Bothell, WA (US); Timothy J. Arnaud, Everett, WA (US)

Correspondence Address: DUKE W. YEE, YEE & ASSOCIATES, P.C., P.O. BOX 802333, DALLAS, TX, 75380, US

(21) Appl. No.: 12/241,389

(22) Filed: Sep. 30, 2008

(51) Int. Cl. B64D 13/00

(52) U.S. Cl. 454/76; 55/290

(57) ABSTRACT

An apparatus comprises an inlet capable of receiving air around a seat, a contaminant conditioning system, an outlet, and a fan system. The contaminant conditioning system may be capable of removing contaminants from the air to form conditioned air. The outlet may be capable of expelling the conditioned air around the seat. The fan system may be capable of drawing the air from a breathing zone through the inlet, moving the air drawn from the inlet to the contaminant conditioning system to form the conditioned air, and moving the conditioned air out of the outlet.

### BACKGROUND INFORMATION

1. Field

The present disclosure relates generally to aircraft and in particular to a method and apparatus for managing air quality in an aircraft. Still more particularly, the present disclosure relates to a method and apparatus for providing personal ventilation in an aircraft.

2. Background

Cabin air systems, in currently available aircraft, are designed to provide a safe and comfortable cabin environment at cruising altitudes. These cruising altitudes may reach upwards of 40,000 feet. At these altitudes, the aircraft cabin is pressurized to enable the passengers and crew to breathe normally. Air enters a passenger area from overhead distribution outlets that run the length of the passenger cabin.

These outlets may be designed to generate circular airflow patterns within the cabin. Air may be exhausted through air returns located in sidewalls near the floor of the cabin. These grills may be located along the length of the cabin and on both sides of the cabin. Air may be supplied and exhausted from the passenger area on a continuous basis.

The air supplied to the cabin contains a mixture of re-circulated air from within the passenger cabin and air from outside of the aircraft. To increase the efficiency of modern jet aircraft and comfort of the aircraft cabin, it may be desirable to increase the ratio of recycled/re-circulated air to outside air. In the early days of jet travel, the aircraft cabin was around 100 percent outside air.

Today, the mix of outside air and re-circulated air may be around 50 percent outside air and around 50 percent re-circulated air. As a result of this change, there was a small increase in humidity levels. However, there may be a concern that an increased level of contaminants may be present in modern jet aircraft cabins due to the increased levels of re-circulated cabin air. Additionally, this increased level of contaminants may decrease passenger enjoyment.

One solution may involve increasing the total airflow to dilute contaminants utilizing high-efficiency particulate air (HEPA) filters for the entire passenger cabin. Other solutions may involve airflow balancing in the cabin to minimize airflow in the fore and aft directions. Further, ultraviolet lights may be included within the aircraft ventilation ducts. The ultraviolet lights may be used to inactivate airborne bacteria and/or viruses.

These systems may remove, dilute, and/or destroy contaminants from the cabin air as it circulates within the aircraft. In these examples, contaminants may include any undesirable particulate. For example, without limitation, a contaminant may be bacteria, viruses, pollen, dust, or other undesirable items. Although these systems may clean air within the passenger cabin, the different advantageous embodiments recognize a limitation with these types of solutions.

Accordingly, there is a need for a method and apparatus for ventilating air in a passenger cabin of an aircraft which overcomes the limitations described above.

### SUMMARY

In one advantageous embodiment, an apparatus may comprise an inlet capable of receiving air around a seat, a contaminant conditioning system, an outlet, and a fan system. The contaminant conditioning system may be capable of removing contaminants from the air to form conditioned air. The outlet may be capable of expelling the conditioned air around the seat. The fan system may be capable of drawing the air from a breathing zone through the inlet, moving the air drawn from the inlet to the contaminant conditioning system to form the conditioned air, and moving the conditioned air out of the outlet.

In another advantageous embodiment, an aircraft may comprise a passenger cabin for the aircraft, a plurality of seats in the passenger cabin, and a plurality of personal ventilation systems. The plurality of personal ventilation systems may be integrated with the plurality of seats in which each personal ventilation system comprises a duct system; an inlet connected to the duct system capable of receiving air; a contaminant conditioning system connected to the duct system capable of removing contaminants from the air to form conditioned air; an outlet connected to the duct system; and a fan system capable of drawing the air from a breathing zone through the inlet, moving the air drawn from the inlet through the duct system to the contaminant conditioning system to form the conditioned air, and moving the conditioned air from the contaminant conditioning system though the duct system to the outlet.

In yet another advantageous embodiment, a personal ventilation system for conditioning air in a passenger cabin may comprise an inlet, a contaminant conditioning system, an outlet, a fan system, a duct system, a vehicle, and a passenger cabin. The inlet may be located in at least one of a head rest and a seatback of a seat, and may be capable of receiving the air around the seat. The contaminant conditioning system may be located in the seat and may have at least one of a high efficiency particulate air filter and an ultraviolet light system capable of removing contaminants from the air to form conditioned air. The outlet may have a number of nozzles located in at least one of the head rest and seatback of the seat and may be capable of expelling the conditioned air around the seat into one of a first breathing zone and a second breathing zone. The fan system may be capable of drawing the air from the first breathing zone through the inlet, moving the air drawn from the inlet to the contaminant conditioning system to form the conditioned air, and moving the conditioned air out of the outlet. The duct system may connect the inlet, the fan, the contaminant conditioning system, and the outlet to each other. The passenger cabin may be located in the vehicle, wherein the inlet, the contaminant conditioning system, the outlet, and the fan system may be located in the passenger cabin. The vehicle may be selected from one of an aircraft, a submarine, a bus, a personnel carrier, a tank, a train, an automobile, a bus, a spacecraft, and a surface ship.

In still yet another advantageous embodiment, a method may be present for processing air. The air may be moved around a seat in a passenger cabin into an inlet to a contaminant conditioning system. Contaminants may be removed from the air to form conditioned air using the contaminant conditioning system. The conditioned air may be expelled through an outlet around the seat.

In a further advantageous embodiment, a method may be present for ventilating air in an aircraft passenger cabin. Air from a first breathing zone may be moved around a seat in a passenger cabin into an inlet to a contaminant conditioning system. Contaminants may be removed from the air to form conditioned air using the contaminant conditioning system. The conditioned air may be expelled through an outlet around the seat into one of the first breathing zone and a second breathing zone around the seat.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is a flow diagram of an aircraft production and service methodology in accordance with an advantageous embodiment;

FIG. 2 is a block diagram of an aircraft in accordance with an advantageous embodiment;

FIG. 3 is a diagram of a personal ventilation system in accordance with an advantageous embodiment;

FIG. 4 is a diagram illustrating a portion of a passenger cabin in accordance with an advantageous embodiment;

FIG. 5 is a diagram of a seat with a personal ventilation system in accordance with an advantageous embodiment;

FIG. 6 is a diagram of a seat with a personal ventilation system in accordance with an advantageous embodiment;

FIG. 7 is diagram of a side view of a seat with a personal ventilation system in accordance with an advantageous embodiment;

FIG. 8 is a diagram illustrating a top cross-sectional view of a seat with a personal ventilation system in accordance with an advantageous embodiment;

FIG. 9 is a top cross-sectional view of a seat with a personal ventilation system in accordance with an advantageous embodiment;

FIG. 10 is a diagram illustrating a top cross-sectional view of a seat with a personal ventilation system in accordance with an advantageous embodiment; and

FIG. 11 is a flowchart of a process for processing air in accordance with an advantageous embodiment.

### DETAILED DESCRIPTION

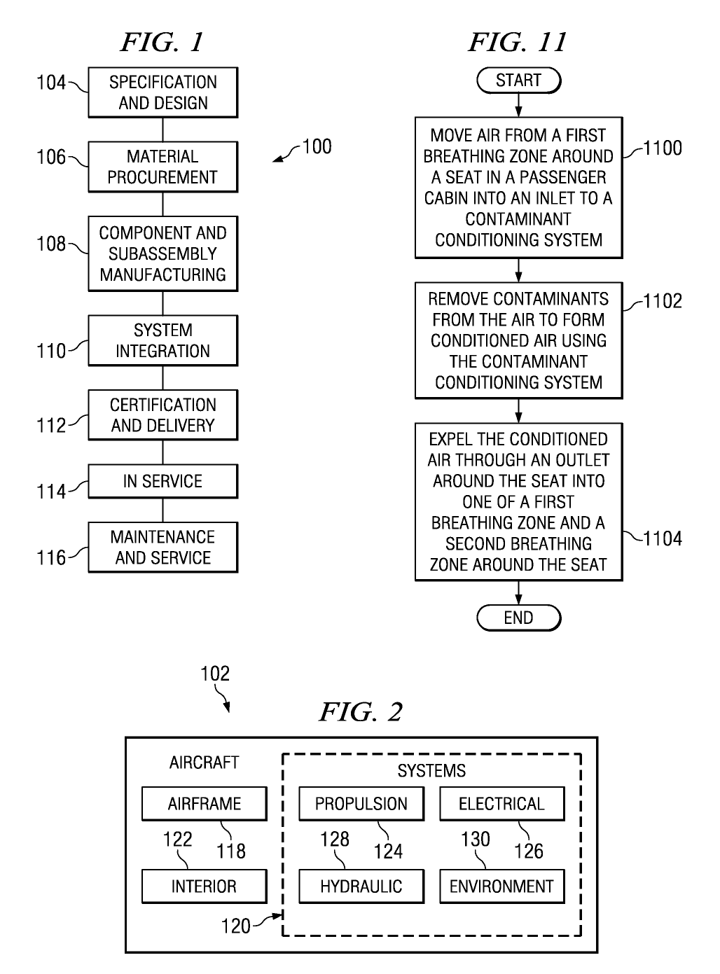

Referring more particularly to the drawings, embodiments of the disclosure may be described in the context of aircraft manufacturing and service method 100 as shown in FIG. 1 and aircraft 102 as shown in FIG. 2. During pre-production, aircraft manufacturing and service method 100 may include specification and design 104 of aircraft 102 and material procurement 106.

During production, component and subassembly manufacturing 108 and system integration 110 of aircraft 102 takes place. Thereafter, aircraft 102 may go through certification and delivery 112 in order to be placed in service 114. While in service by a customer, aircraft 102 is scheduled for routine maintenance and service 116 (which may also include modification, reconfiguration, refurbishment, and so on).

Each of the processes of aircraft manufacturing and service method 100 may be performed or carried out by a system integrator, a third party, and/or an operator (e.g., a customer). For the purposes of this description, a system integrator may include, without limitation, any number of aircraft manufacturers and major-system subcontractors; a third party may include, for example, without limitation, any number of venders, subcontractors, and suppliers; and an operator may be an airline, leasing company, military entity, service organization, and so on.

As shown in FIG. 2, aircraft 102 produced by aircraft manufacturing and service method 100 may include airframe 118 with a plurality of systems 120 and interior 122. Examples of systems 120 include one or more of propulsion system 124, electrical system 126, hydraulic system 128, and environmental system 130. Any number of other systems may be included in this example. Although an aerospace example is shown, the principles of the disclosure may be applied to other industries, such as the automotive industry.

Apparatus and methods embodied herein may be employed during any one or more of the stages of aircraft manufacturing and service method 100. For example, without limitation, components or subassemblies corresponding to component and subassembly manufacturing 108 may be fabricated or manufactured in a manner similar to components or subassemblies produced while aircraft 102 is in service.

Also, one or more apparatus embodiments, method embodiments, or a combination thereof may be utilized during component and subassembly manufacturing 108 and system integration 110, for example, without limitation, by substantially expediting assembly of or reducing the cost of aircraft 102. Similarly, one or more of apparatus embodiments, method embodiments, or a combination thereof may be utilized while aircraft 102 is in service, for example, without limitation, to maintenance and service 116.

The different advantageous embodiments recognize and take into account that with currently available passenger cabin ventilation systems for aircraft, the circulation patterns may be inadequate for limiting air exhaled from one passenger from flowing into the breathing zone of another passenger.

The different advantageous embodiments recognize and take into account that currently available passenger cabin ventilation systems may generate air circulation patterns in which air is introduced into the cabin and removed from the cabin using airflows that may travel through breathing zones for multiple passengers. In these examples, a breathing zone may be any area within a passenger cabin in which air is present that may be inhaled by a particular passenger.

The different advantageous embodiments recognize that the current high-efficiency particulate air filters may only work once the air has left the cabin and has then gone through the recirculation system. This type of recirculation, however, does not take into account that passengers may inhale air that has been exhaled by passengers nearby. The different advantageous embodiments also recognize that increased airflow may only dilute contaminants. The higher airflow may require increased fan speeds, with a higher cost of fuel for this type of ventilation.

Thus, the different advantageous embodiments provide a method and apparatus to provide personal ventilation within a passenger cabin of an aircraft. In the different advantageous embodiments, air exhaled by a passenger may be conditioned in a manner that reduces and/or prevents contaminants contained in the exhaled air from one passenger from entering a breathing zone of another passenger.

The different advantageous embodiments provide a method and apparatus for conditioning air. In one advantageous embodiment, an apparatus may include an inlet, an outlet, a contaminant conditioning system, and a fan system. The inlet may be capable of receiving air around a seat. The contaminant conditioning system may be capable of removing contaminants from the air to form conditioned air. The outlet may be capable of expelling the conditioned air around the seat. The fan system may be capable of drawing air from a breathing zone through the inlet, moving the air drawn from the inlet to the contaminant conditioning system to form the conditioned air, and moving the conditioned air out of the outlet.

These components may be connected to each other through a duct system. Further, the air may be expelled into the original passenger's breathing zone or into a different passenger's breathing zone.

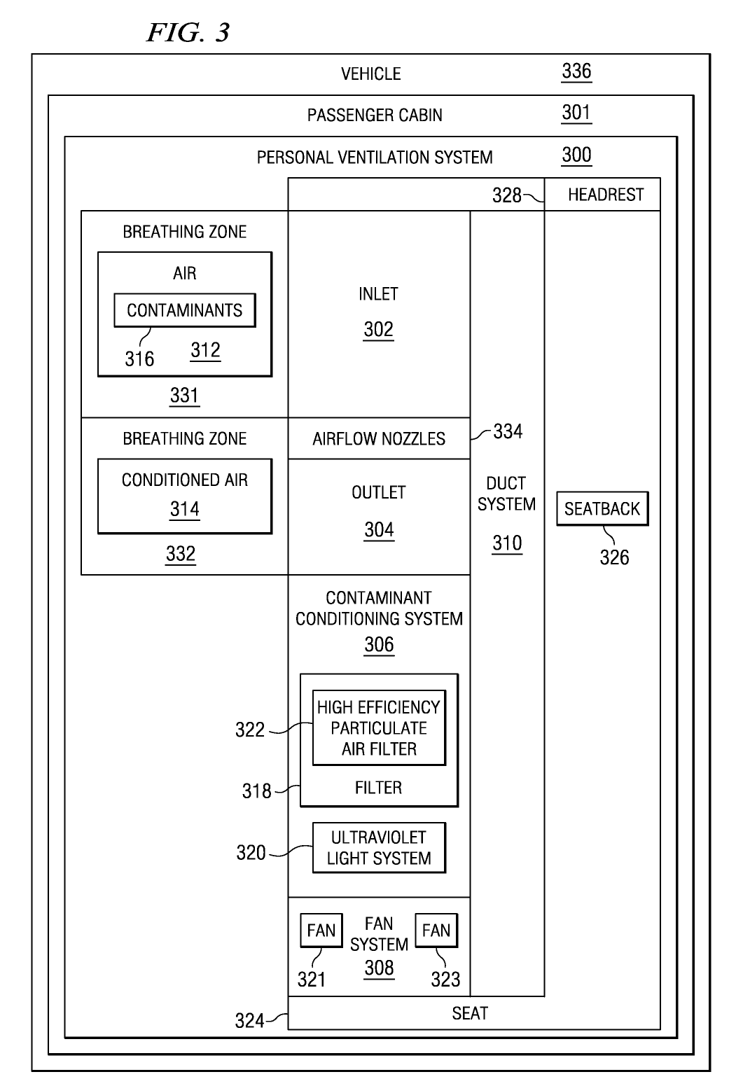

With reference now to FIG. 3, a diagram of a personal ventilation system is depicted in accordance with an advantageous embodiment. Personal ventilation system 300 is an example of a personal ventilation system that may be implemented in environmental system 130 of aircraft 102 in FIG. 2.

In this example, personal ventilation system 300 may be located within passenger cabin 301. In this example, personal ventilation system 300 may include inlet 302, outlet 304, contaminant conditioning system 306, fan system 308, and duct system 310. Inlet 302 may receive air, while outlet 304 may expel air processed by personal ventilation system 300.

Contaminant conditioning system 306 includes filter 318, ultraviolet light system 320, and any other suitable contaminant removal system. For example, without limitation, in other advantageous embodiments, an electrostatic device may be used to remove contaminants. In these examples, filter 318 may take the form of high efficiency particulate air filter 322.

Contaminant conditioning system 306 may be capable of removing contaminants from air 312 to form conditioned air 314. In these examples, without limitation, contaminants may be removed by physically removing the contaminants and/or rendering the contaminants incapable of causing undesired effects.

For example, without limitation, bacteria and/or viruses may be destroyed and/or rendered inert. In another example, bacteria and/or pollen may be removed from air 312. In these examples, contaminants 316 in air 312 may be removed by filter 318 and/or ultraviolet light system 320. This physical removal and/or inactivating of contaminants in air 312 may also be referred to as conditioning air.

Duct system 310 interconnects inlet 302, outlet 304, contaminant conditioning system 306, and fan system 308. Duct system 310 may be an enclosure that may be capable of allowing air 312 to flow within personal ventilation system 300. For example, without limitation, duct system 310 may comprise channels, tubes, interior spaces, or some other suitable system. Fan system 308 may contain a number of fans. In this example, fan system 308 may have fan 321 and fan 323. Of course, any suitable number of fans may be employed in fan system 308. Fan system 308 may be capable of moving air through the different components. Fan system 308 may be capable of moving air through outlet 304 into duct system 310.

In these examples, at least one of inlet 302, outlet 304, contaminant conditioning system 306, fan system 308, and duct system 310 may be integrated in seat 324. Inlet 302 and outlet 304 may be located in seatback 326. In other advantageous embodiments, one or more of inlet 302 and/or outlet 304 may be located in headrest 328. Of course, without limitation, the location of these components may vary depending on the particular implementation.

As used herein, the phrase “at least one of”, when used with a list of items, means that different combinations of one or more of the items may be used, and only one of each item in the list may be needed. For example, “at least one of item A, item B, and item C” may include, for example, without limitation, item A, or item A and item B. This example also may include item A, item B, and item C, or item B and item C.

In operation, air 312 may be drawn in from breathing zone 331 through inlet 302 by fan system 308. Air 312 may be circulated and/or moved through duct system 310 to contaminant conditioning system 306. Contaminant conditioning system 306 may generate conditioned air 314. Conditioned air 314 may then be moved through duct system 310 out into breathing zone 332 through airflow nozzles 334 in outlet 304.

In different advantageous embodiments, breathing zone 331 and breathing zone 332 may be the same breathing zone for a particular passenger. In other advantageous embodiments, breathing zone 331 may be a breathing zone for one passenger, while breathing zone 332 may be a breathing zone for another passenger. A breathing zone is defined as an area in which air may be inhaled and exhaled by an individual passenger while occupying their given seat.

In this manner, contaminants may be removed, while the air may still be within a breathing zone of a passenger. This type of conditioning of air may avoid contaminants being inhaled by passengers in adjacent breathing zones, as compared to currently available passenger cabin ventilation systems.

In these examples, passenger cabin 301 may be located within vehicle 336. Vehicle 336 may take various forms. For example, without limitation, vehicle 336 may be, without limitation, an aircraft, a submarine, a bus, a personnel carrier, a tank, a train, an automobile, a spacecraft, a surface ship, and/or some other suitable vehicle that permits a plurality of occupants.

The illustration of personal ventilation system 300 in FIG. 3 is not meant to imply physical and/or architectural limitations to the manner in which different advantageous embodiments may be implemented. Other components in addition to or in place of the ones illustrated in FIG. 3 may be used. For example, without limitation, fan system 308 may be located under the passenger floor of passenger cabin 301, rather than being integrated into seat 324. In another example, inlet 302 may be located in a seat cushion area, rather than headrest 328 and/or seatback 326.

For example, in one advantageous embodiment, inlet 302 and outlet 304 may be located around headrest 328 of seatback 326. In this type of implementation, inlet 302 and outlet 304 may be located on the same side of headrest 328. In particular, the side may be that of a passenger's head. Inlet 302 may draw air 312 through contaminant conditioning system 306 using fan 308. Conditioned air 314 may be sent back through outlet 304 and headrest 328. In this type of advantageous embodiment, breathing zone 331 and breathing zone 332 may be the same breathing zone.

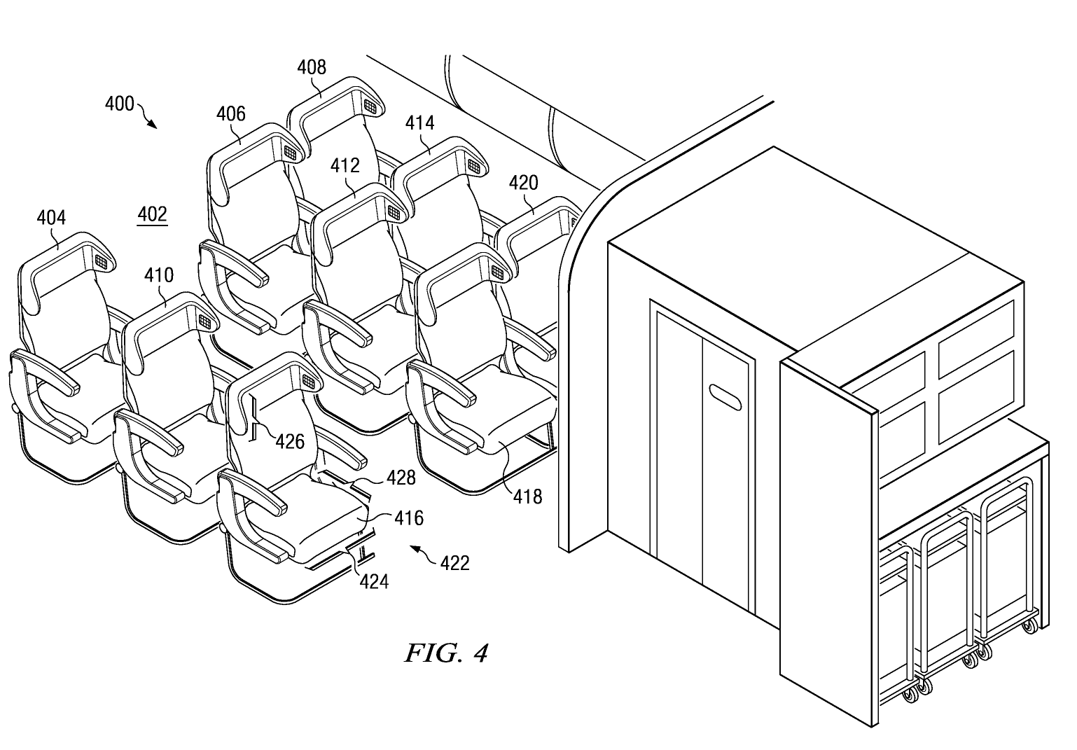

With reference now to FIG. 4, a diagram illustrating a portion of a passenger cabin is depicted in accordance with an advantageous embodiment. In this example, passenger cabin 400 is an example of one implementation of passenger cabin 301 in FIG. 3.

As can be seen in this example, passenger cabin 400 may have passenger area 402, in which seats 404, 406, 408, 410, 412, 414, 416, 418, and 420 may be located. These seats may be examples of seats in which a personal ventilation system such as, for example, without limitation, personal ventilation system 300 in FIG. 3 may be located.

Within passenger cabin 400, a breathing zone may be present with respect to each of seats 404, 406, 408, 410, 412, 414, 416, 418, and 420. For example, without limitation, breathing zone 422 may be around width 424, height 426, and depth 428 of passenger seat 416. Height 426 may be from the top of a passenger's shoulders to the top of their head in a seated position within seat 416.

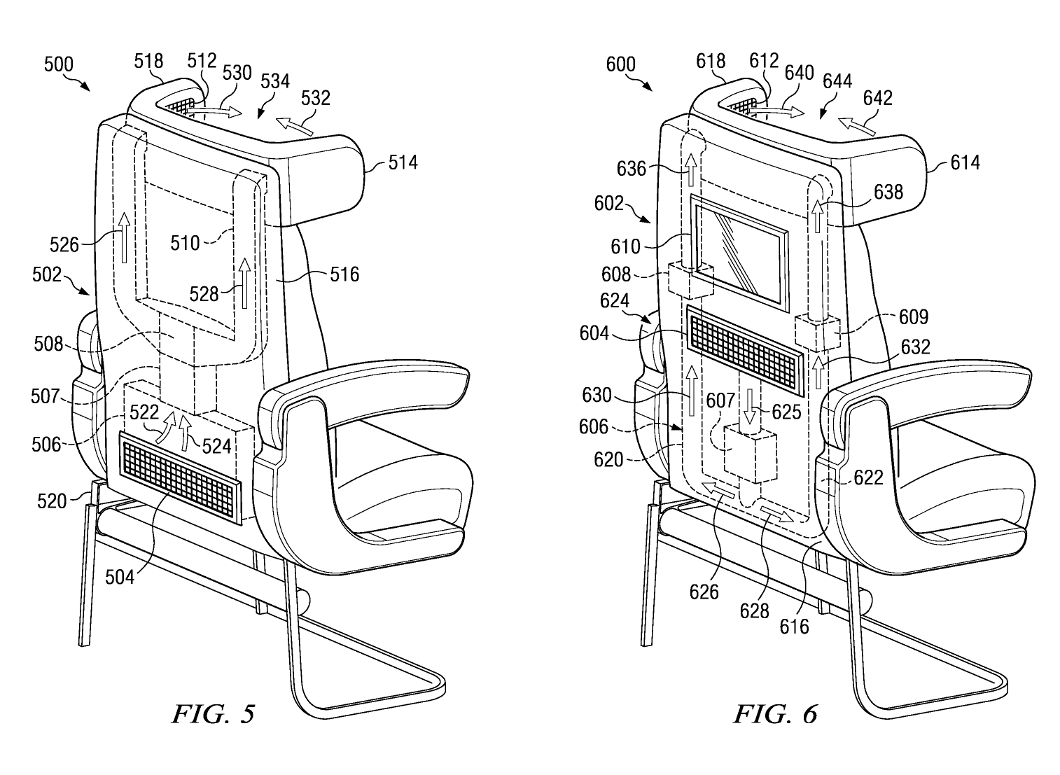

With reference now to FIG. 5, a diagram of a seat with a personal ventilation system is depicted in accordance with an advantageous embodiment. In this example, seat 500 is an example of one implementation of a seat within passenger cabin 400 in FIG. 4, and is one example of the manner in which seat 324 in FIG. 3 may be implemented. In this example, seat 500 may contain personal ventilation system 502. Personal ventilation system 502 may include inlet 504, ultraviolet light unit 506, fan 507, filter 508, duct system 510, outlet 512, and outlet 514. Inlet 504, ultraviolet light unit 506, fan 507, filter 508, and duct system 510 may be integrated within seatback 516 of seat 500. Outlet 512 and outlet 514 may be located in headrest 518.

In this illustrative example, air may be drawn into inlet 504 from breathing zone 520 by fan 507 and travel through ultraviolet light unit 506 in the direction of arrows 522 and 524. As air travels through ultraviolet light unit 506, various contaminants may be removed. In these examples, a contaminant may be considered to be removed when the contaminant is inactivated or no longer capable of being considered a contaminant. For example, without limitation, ultraviolet light unit 506 may inactivate bacteria and/or viruses to render those contaminants incapable of causing undesired effects. This inactivated state may be considered a removal of a contaminant in these illustrative embodiments.

The air may then move into filter 508, which may physically remove contaminants from the air to form conditioned air. Thereafter, the air may travel through duct system 510 in the direction of arrows 526 and 528 to be expelled through outlets 512 and 514 around seat 500, as illustrated by arrows 530 and 532, into breathing zone 534.

With reference now to FIG. 6, a diagram of a seat with a personal ventilation system is depicted in accordance with an advantageous embodiment. In this example, seat 600 is another example of an implementation of a seat within passenger cabin 400 in FIG. 4 and is an example of one manner in which seat 324 in FIG. 3 may be implemented. Personal ventilation system 602 may include inlet 604, ultraviolet light unit 606, fan 607, filter 608, filter 609, duct system 610, outlet 612, and outlet 614. Inlet 604, ultraviolet light unit 606, fan 607, filter 608, filter 609, and duct system 610 may be incorporated within seatback 616. Outlet 612 and outlet 614 may be located in headrest 618.

In this example, ultraviolet light unit 606 may comprise ultraviolet light chamber 620 and ultraviolet light chamber 622. Ultraviolet light may be emitted within ultraviolet light chamber 620 and ultraviolet light chamber 622 to inactivate contaminants in air passing through ultraviolet light chamber 620 and ultraviolet light chamber 622. In this example, air from breathing zone 624 may be drawn into inlet 604 by fan 607 in the direction of arrow 625 and move along the direction of arrows 626, 628, 630, and 632 through ultraviolet light chamber 620 and ultraviolet light chamber 622.

Thereafter, air may travel through filter 608 and filter 609 to further remove contaminants from the air to form conditioned air that travels through duct system 610 in the direction of arrows 636 and 638. The conditioned air may then be expelled through outlet 612 and 614 in the direction of arrows 640 and 642 into breathing zone 644 as conditioned air.

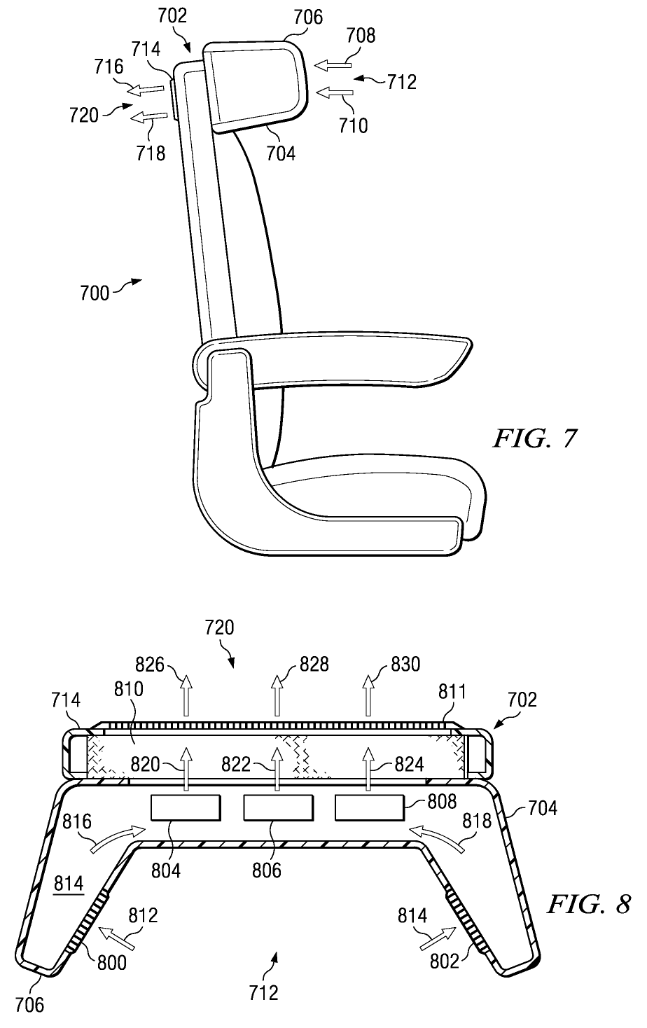

With reference now to FIG. 7, a diagram of a side view of a seat with a personal ventilation system is depicted in accordance with an advantageous embodiment. Seat 700 is an example of a seat that may be found in passenger cabin 400 in FIG. 4 and is an example of one implementation for seat 324 in FIG. 3.

Personal ventilation system 702 may be located in headrest 704 in these examples. With this type of implementation, air may be moved into front side 706 of headrest 704 in the direction of arrows 708 and 710 from breathing zone 712. The air may be conditioned through the removal of contaminants as the air moves through headrest 704 and may be expelled from backside 714 in the direction of arrows 716 and 718 into breathing zone 720.

With reference now to FIG. 8, a diagram illustrating a top cross-sectional view of a seat with a personal ventilation system is depicted in accordance with an advantageous embodiment. In this example, personal ventilation system 702 may include inlet 800, inlet 802, fan 804, fan 806, fan 808, filter 810, outlet 811, and duct system 814.

In this example, fans 804, 806, and 808 may draw air from breathing zone 712 into inlets 800 and 802 as indicated by arrows 812 and 814. The air may then travel through duct system 814 of headrest 704 in the direction of arrows 816 and 818 through fans 804, 806, and 808. Fans 804, 806, and 808 may then push air through filter 810 as illustrated by arrows 820, 822, and 824. As air moves through filter 810, contaminants may be removed from the air. The conditioned air may then be expelled through outlet 811 as shown in the direction of arrows 826, 828, and 830 into breathing zone 720.

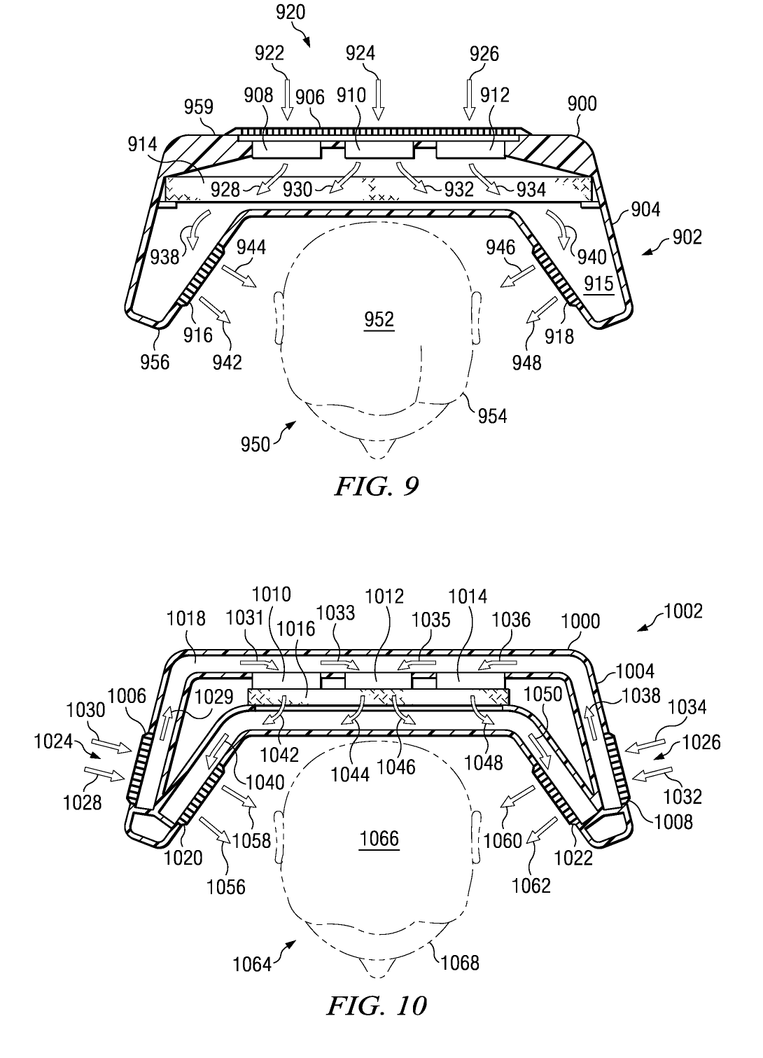

With reference now to FIG. 9, a top cross-sectional view of a seat with a personal ventilation system is depicted in accordance with an advantageous embodiment. In this embodiment, seat 900 may have personal ventilation system 902 located within headrest 904. Personal ventilation system 902 may include inlet 906, fan 908, fan 910, fan 912, filter 914, duct system 915, outlet 916, and outlet 918.

In this illustrative example, air may be drawn into inlet 906 from breathing zone 920 by fans 908, 910, and 912 in the direction of arrows 922, 924, and 926. Fans 908, 910, and 912 may push the air through filter 914 as shown in the direction of arrows 928, 930, 932, and 934. Filter 914 may remove contaminants from the air to form conditioned air, which may be moved through duct system 915 of headrest 904 in the direction of arrows 938 and 940. The air may then flow out through outlets 916 and 918 in the direction of arrows 942, 944, 946, and 948 into breathing zone 950 around head 952 of passenger 954. As can be seen in this example, air may flow from backside 959 of headrest 904 to frontside 956 of headrest 904.

With reference now to FIG. 10, a diagram illustrating a top cross-sectional view of a seat with a personal ventilation system is depicted in accordance with an advantageous embodiment. In this example, seat 1000 illustrates the top cross-sectional view of a seat within passenger cabin 400 in FIG. 4 and is an example of one implementation of seat 324 in FIG. 3.

In this example, seat 1000 may include personal ventilation system 1002 within headrest 1004. Personal ventilation system 1002 may include inlet 1006, inlet 1008, fan 1010, fan 1012, fan 1014, filter 1016, duct system 1018, outlet 1020, and outlet 1022.

In this example, air may be drawn into inlet 1006 and 1008 from breathing zone 1024 and 1026, respectively, as shown by arrows 1028, 1030, 1032, and 1034 by fans 1010, 1012, and 1014. Air may move within duct system 1018 in the direction as shown by arrows 1029, 1031, 1033, 1035, 1036, and 1038. The air may be pushed through filter 1016 to remove contaminants to form conditioned air, which may move in the direction of arrows 1040, 1042, 1044, 1046, 1048, and 1050 within duct system 1018.

The conditioned air may then be expelled through outlets 1020 and 1022 in the direction of arrows 1056, 1058, 1060, and 1062 into breathing zone 1064 around head 1066 of passenger 1068.

The illustration of seats with personal ventilation systems in FIGS. 5-10 are not meant to imply physical or architectural limitations to the manner in which other personal ventilation systems may be implemented. Other personal ventilation systems may be implemented using other components in addition to or in place of the ones illustrated in these examples.

Further, the components may be located in different locations within the seat or in other locations within the passenger cabin depending on the particular implementation. For example, without limitation, the fan and a portion of the duct work may be located within the cabin floor rather than within the seat themselves. In other advantageous embodiments, more than one inlet may be present within a seatback, while in other advantageous embodiments, air may be expelled into a breathing zone from armrests.

With reference now to FIG. 11, a flowchart of a process for processing air is depicted in accordance with an advantageous embodiment. The process illustrated in FIG. 11 may be implemented using a personal ventilation system such as, for example, without limitation, personal ventilation system 300 in FIG. 3.

The process may begin by moving air from a first breathing zone around a seat in a passenger cabin into an inlet to a contaminant conditioning system (operation 1100). The process may remove contaminants from the air to form conditioned air using the contaminant conditioning system (operation 1102). Next, the process may expel the conditioned air through an outlet around the seat into one of a first breathing zone and a second breathing zone around the seat (operation 1104), with the process terminating thereafter.

Thus, the different advantageous embodiments provide a method and apparatus for conditioning air within an aircraft. In the different advantageous embodiments, air may be drawn in from a breathing zone, conditioned, and expelled into the same breathing zone or another breathing zone. In this manner, air may be processed to remove contaminants before possibly being inhaled by other passengers.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments.

The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
an inlet capable of receiving air around a seat;
a contaminant conditioning system capable of removing contaminants from the air to form conditioned air;
an outlet capable of expelling the conditioned air around the seat; and
a fan system capable of drawing the air from a breathing zone through the inlet, moving the air drawn from the inlet to the contaminant conditioning system to form the conditioned air, and moving the conditioned air out of the outlet.

2. The apparatus of claim 1 further comprising:
a duct system connecting the inlet, the fan, the contaminant conditioning system, and the outlet to each other.

3. The apparatus of claim 1, wherein the outlet comprises a number of nozzles located in the seat.

4. The apparatus of claim 1, wherein the inlet and the outlet are located in the seat.

5. The apparatus of claim 4, wherein the contaminant conditioning system is located in the seat.

6. The apparatus of claim 4, wherein the fan system is located in the seat.

7. The apparatus of claim 4, wherein the inlet and the outlet are located in a seatback of the seat.

8. The apparatus of claim 4, wherein the inlet is located in a head rest and the outlet is located in a seat back of the seat.

9. The apparatus of claim 1, wherein the conditioned air is moved back into the breathing zone.

10. The apparatus of claim 1, wherein the breathing zone is a first breathing zone and wherein the conditioned air is moved through the outlet into a second breathing zone.

11. The apparatus of claim 1, wherein the contaminant conditioning system comprises at least one of a filter and an ultraviolet light system.

12. The apparatus of claim 11, wherein the filter is a high efficiency particulate air filter.

13. The apparatus of claim 1 further comprising:
a vehicle; and
a passenger cabin located in the vehicle, wherein the inlet, the contaminant conditioning system, the outlet, and the fan system are located in the passenger cabin.

14. The apparatus of claim 13, wherein the vehicle is selected from one of an aircraft, a submarine, a bus, a personnel carrier, a tank, a train, an automobile, a spacecraft, and a surface ship.

15. An aircraft comprising:
a passenger cabin for the aircraft;
a plurality of seats in the passenger cabin; and
a plurality of personal ventilation systems integrated with the plurality of seats in which each personal ventilation system comprises a duct system, an inlet connected to the duct system capable of receiving air; a contaminant conditioning system connected to the duct system and capable of removing contaminants from the air to form conditioned air; an outlet connected to the duct system; and a fan system capable of drawing the air from a breathing zone through the inlet, moving the air drawn from the inlet through the duct system to the contaminant conditioning system to form the conditioned air, and moving the conditioned air from the contaminant conditioning system though the duct system to the outlet.

16. A personal ventilation system for conditioning air in a passenger cabin, the personal ventilation system comprising:
an inlet located in at least one of a head rest and a seatback of a seat, wherein the inlet is capable of receiving the air from around the seat;
a contaminant conditioning system located in the seat, wherein the contaminant conditioning system has at least one of a high efficiency particulate air filter and an ultraviolet light system capable of removing contaminants from the air to form conditioned air;
an outlet having a number of nozzles located in at least one of the head rest and seatback of the seat, wherein the outlet is capable of expelling the conditioned air around the seat into one of a first breathing zone and a second breathing zone;
a fan system capable of drawing the air from the first breathing zone through the inlet, moving the air drawn from the inlet to the contaminant conditioning system to form the conditioned air, and moving the conditioned air out of the outlet;
a duct system connecting the inlet, the fan, the contaminant conditioning system, and the outlet to each other;
a vehicle; and
a passenger cabin located in the vehicle, wherein the inlet, the contaminant conditioning system, the outlet, and the fan system are located in the passenger cabin, wherein the vehicle is selected from one of an aircraft, a submarine, a bus, a personnel carrier, a tank, a train, an automobile, a spacecraft, and a surface ship.

17. A method for processing air, the method comprising:
moving the air around a seat in a passenger cabin into an inlet to a contaminant conditioning system;
removing contaminants from the air to form conditioned air using the contaminant conditioning system; and
expelling the conditioned air through an outlet around the seat.

18. The method of claim 17, wherein the air is moved from a first breathing zone around the seat into the inlet and expelled through the outlet into a second breathing zone around the seat.

19. The method of claim 17, wherein the air is moved from a breathing zone around the seat into the inlet and expelled through the outlet into the breathing zone around the seat.

20. The method of claim 17, wherein the contaminants are removed from the air in a breathing zone around the seat in the passenger cabin before the air moves into another breathing zone.

21. A method for ventilating air in an aircraft passenger cabin, the method comprising:
moving the air from a first breathing zone around a seat in a passenger cabin into an inlet to a contaminant conditioning system;
removing contaminants from the air to form conditioned air using the contaminant conditioning system; and
expelling the conditioned air through an outlet around the seat into one of the first breathing zone and a second breathing zone around the seat.
